(19) United States
(12) Patent Application Publication
(10) Pub. No.: US 2004/0112966 A1
(43) Pub. Date: Jun. 17, 2004

(54) Non-contact portable object comprising at least a peripheral device connected to the same atenna as the chip

(76) Inventor: Nicolas Pangaud, Valbonne (FR)

Correspondence Address: Gregory J Lavorgna, Drinker Biddle & Reath, One Logan Square, 18th and Cherry Streets, Philadelphia, PA, 19103-6996, US

(21) Appl. No.: 10/469,416

(22) PCT Filed: Dec. 24, 2002
(86) PCT No.: PCT/FR02/04560

(30) Foreign Application Priority Data
Dec. 28, 2001 (FR) 01/17000

(51) Int. Cl. G06K 19/06

(52) U.S. Cl. 235/492

(57) ABSTRACT

A contactless portable object (10) featuring a main chip (12) and an antenna (14) enabling electromagnetic signals to be communicated between the chip and a reader associated to the contactless portable object, the antenna terminals being connected to the terminals of the main chip. The contactless portable object features at least one contactless peripheral device (16, 18), having a function different from the main chip, also connected in parallel to the antenna's terminals and whose energy required to operate is supplied by the antenna.

### TECHNICAL FIELD

The present invention concerns contactless portable objects and more specifically a contactless portable object featuring a chip and at least one peripheral device connected to the same antenna.

### BACKGROUND

Portable objects, such as contactless smart cards, are currently widely used in numerous applications. It generally entails ISO format cards which are coupled to readers, through which they are remotely energized, that is, by which they receive energy in the form of electromagnetic signals and with which they communicate. In the public transport sector, such means are also implemented in the form of ISO cards or in smaller form such as tickets. Users present the cards or tickets in front of readers in order to gain access to public transport. The communication which is established with the reader enables user recognition and the cost of the trip to be deducted from the user's account.

These objects have also been developed as a means of payment. This is the case, for example, of the electronic wallet. The latter can be used to pay for small purchases in shops. It consists of a smart card. This card is credited in a specialized distributor. The user may thus use it to pay for purchases by presenting it in front of a reader. The communication established between the card and the reader debits the sum corresponding to the purchase.

Many companies has also developed identification means for their personnel using contactless smart cards. Passing the card in front of a reader allows the cardholder to be identified, and then to be granted or denied access to a controlled access zone. The same card can also be used by employees to “punch in”.

The increasing use of smart card technology has given rise to new needs to which current cards do not respond. The first of these needs is the possibility to be able to read the information directly on the contactless portable object.

The user wants to be able to consult the information contained in the smart card without having to place the card in the field of a reader, and then read the information directly on the reader's display screen. This problem is encountered, for example, when using the electronic wallet. The user can only consult the balance when he/she transfers money to the card or when making a transaction, that is when power is supplied to the card by means of the electromagnetic signals emitted by the reader.

A means for eliminating these drawbacks is available on the market. This means is a case designed for electronic wallet cards which features a display screen allowing the user to consult the card balance at all times. By inserting the latter into the case, contact is made between the card's chip and that of the case. The communication established via the contact results in the balance being displayed on the case's display screen. This technology, however, presents several drawbacks. The first of these inconveniences is that the case requires an internal power source allowing the case and the communication between the card and the case to function. This power source is generally a battery. This battery must thus be changed regularly when depleted. The second drawback resides in the fact that the case only accepts cards that are specifically configured to operate with it. As such, several cards cannot be used with it.

A second need is the possibility to use the same card for several applications. One can imagine that just one card could communicate with different readers. In this manner, a credit card operating in automatic teller machines may be used as an electronic wallet. In the same respect, a contactless transport card may be used for purchases of small amounts. The same card thus becomes an accessory capable of being used on a daily basis in several different applications.

A third need may be to incorporate a small keyboard onto the contactless smart card enabling data to be entered during a transaction between the card and a terminal. Such a keyboard would be placed on the body of the smart card.

Unfortunately, the various functions required to satisfy these needs require an energy source to operate when the card is in the magnetic field emitted by the reader with which it communicates.

### SUMMARY OF THE INVENTION

The purpose of the invention is to mitigate these drawbacks by supplying a portable object having several independent functions implemented by one or more independent peripheral devices connected to the same antenna.

The present invention concerns a contactless portable object featuring a main chip, an antenna enabling electromagnetic signals to be communicated between the chip and a reader associated to the contactless portable object, the antenna terminals being connected to the terminals of the main chip and at least one contactless peripheral device other than a chip and having a function different than the main chip, also connected in parallel to the terminals of the antenna and whose energy required to operate is supplied by the antenna.

### BRIEF DESCRIPTION OF THE DRAWINGS

The purposes, objects and characteristics of the invention will become more apparent from the following description when taken in conjunction with the accompanying drawings in which:

FIG. 1 represents a contactless portable object featuring in addition to the main chip, a temperature sensor and a display device connected to the antenna terminals according to the principles of the invention,

FIG. 2 represents the electrical diagram of a contactless smart card featuring a single chip,

FIG. 3 represents the electrical diagram of a contactless smart card featuring a peripheral device in addition to the main chip, and

FIG. 4 represents the electrical diagram equivalent to that of FIG. 3.

### DETAIL DESCRIPTION OF THE INVENTION

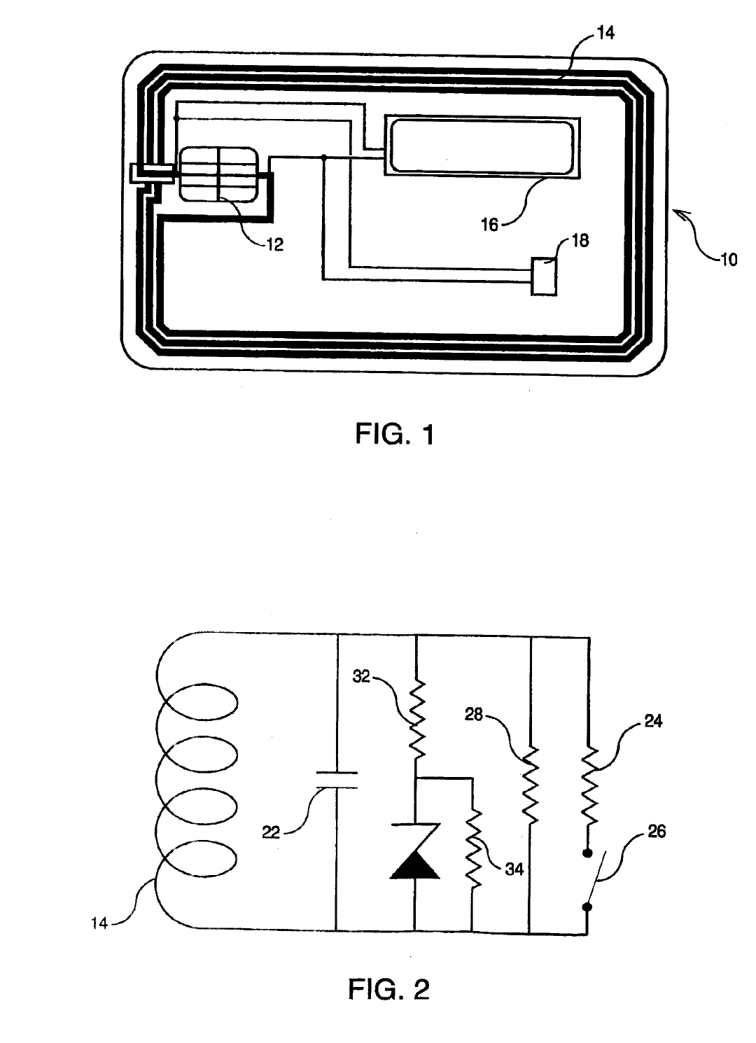

FIG. 1 represents an ISO format contactless smart card. The card 10 includes a main chip 12. This chip dialogs with a reader through an antenna 14. When the card is placed in the magnetic field generated by the reader, electromagnetic coupling occurs between the chip 12 and the reader. Then, the data and the energy transit between the chip and the reader by means of their respective antenna. The antenna 14 consists of spires of increasing circumference. Both ends of this antenna are connected to the chip 12. The smart card 10 also includes two peripheral devices 16 and 18.

In the example given in FIG. 1, the peripheral devices 16 and 18 consist of display device and a temperature sensor, respectively, both being connected in parallel to the terminals of the main chip 12. It should be noted that the peripheral devices placed on the card may be of the same type or of different type as is the case in FIG. 1. According to other embodiments, the card 10 may feature one single peripheral device or more than two peripheral devices, depending on requirements.

According to an essential characteristic of the invention, all of the peripheral devices placed on the card 10 are connected in parallel to the terminals of the main chip, that is to the terminals of the antenna 14. In this manner, each of the peripheral devices can, as the main chip, receive data and its operating energy through electromagnetic coupling between the reader's antenna and the card's antenna 14.

FIG. 2 represents the electrical diagram of a traditional smart card not having peripheral devices. The circuit first includes the antenna 14 and a capacitor 22 made up of the combination of a capacitor and the parasite capacitance of the chip. The capacitor 22 is in fact a tuning capacitor enabling, in combination with the antenna 14, the formation of a circuit resonating at the frequency of the electromagnetic signals transmitted by the reader. The frequency at which resonance occurs is equal to 13.56 megahertz (MHz) according to the current standard. The resistor 24 may be connected in parallel by means of an electronic switch 26 inside the chip, in order to generate a retromodulation subcarrier frequency between the smart card and the reader. According to a specific example which corresponds to current standards, the value of the retromodulation subcarrier frequency is 847 Kilohertz (kHz). This retromodulation subcarrier frequency enables the smart card to send information to the reader. Aside from the components already mentioned, the resistor 28 represents the intrinsic resistance of the chip, and the assembly provided by the zener diode 30 and the resistors 32 and 34 is designed to limit the voltage at the terminals of the antenna 14.

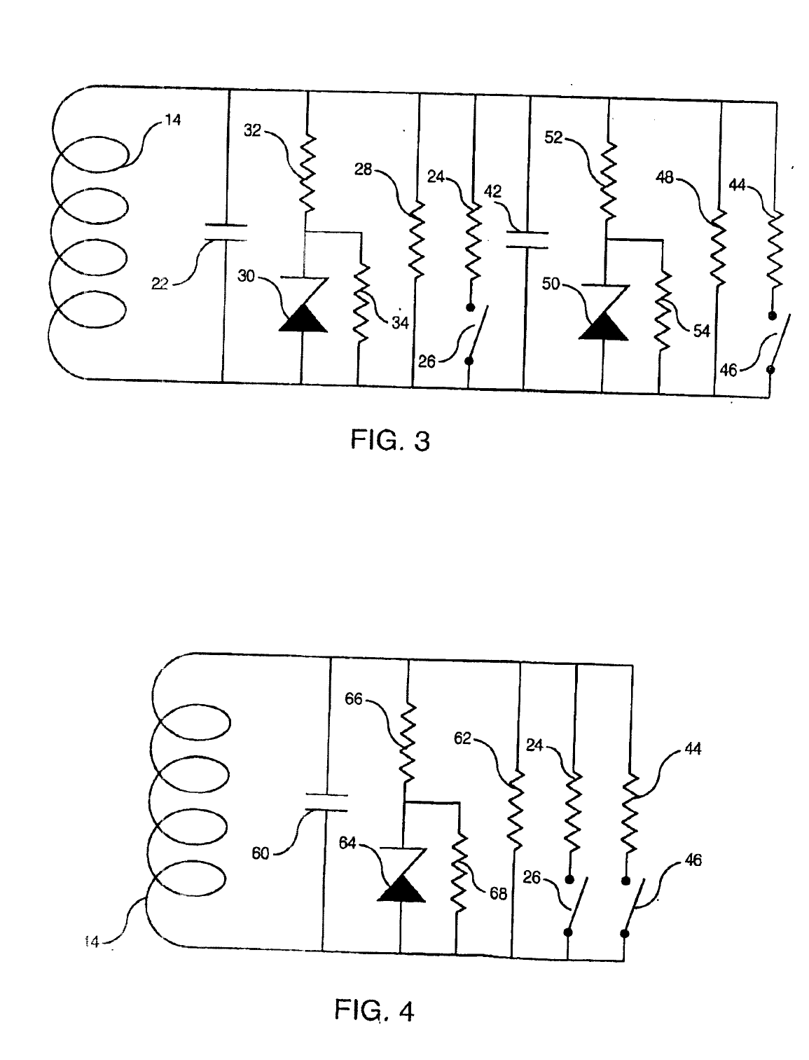

Regardless of the peripheral device built into the card in addition to the main chip, it will also feature a chip. But conversely to the main chip of the card, this chip is used as a processor for implementing the function of the peripheral device. As a result, its diagram will be similar to that of FIG. 2 and will include the same types of components as that of the main chip. Supposing that a peripheral device(display device, sensor, keyboard or other) is connected in parallel on the antenna and the main chip, the electrical diagram of the assembly appears as the combination of electrical circuits of the same type as that of FIG. 2 as represented in FIG. 3.

The second circuit connected in parallel to the terminals of the antenna 14, thus includes a capacitor 42 which represents at least the parasite capacitance of the peripheral device, a resistor 44 connected in parallel by means of a switch 46 in order to generate a retromodulation subcarrier frequency between the peripheral device and the reader and to thus enable the peripheral device to send data to the reader. Finally, the resistor 48 is a resistor equivalent to that of the peripheral device, and the assembly formed by the zener diode 50 and resistors 52 and 54 is designed to limit the voltage at the terminals of the antenna 14.

In reality, the electric circuit of FIG. 3 can be reduced to the circuit illustrated in FIG. 4. Insofar as the card feature only one antenna, the capacitor 60, equivalent to the capacitors 22 and 42, that is to say their sum, must be the tuning capacitor for which the value is that for which the circuit formed by the antenna 14 and the tuning capacitor resonates at the carrier frequency transmitted by the reader. It should be noted that the tuning capacitor of the peripheral device is generally weaker than that of the main chip such that 75% of the overall capacitance is distributed to the capacitance of the main chip and 25% to the capacitance of the peripheral device. Furthermore, the resistor 62 is the resistor equivalent to the two resistors 28 and 48 in parallel. Concerning the assembly formed by the zener diode 64 and the resistors 66 and 68, it is in fact the assembly of the diode 30 and the resistors 32 and 34 or the assembly of the diode 50 and the resistors 52 and 54 which has the least elevated threshold.

The electric circuit illustrated in FIG. 4 includes two switching elements. The resistor 24 and the switch 26 (when closed) is used to transmit information from the main chip to the reader at a certain frequency (847 kHz, for example), while the resistor 44 and the switch 46 (when closed) are used to transmit information from the peripheral device to the reader at a frequency which may be different from that used by the main chip. It should be noted that there are as many switching elements formed by a resistor and a switch as there are peripheral devices, including the main chip, present on the card. As mentioned above, the modulation being used for the transmission of the information from each peripheral device is a modulation based upon a phase change at each bit resulting in a state change of the associated switch.

Generally speaking, the peripheral devices present on the card may operate with the same reader as the main chip or with different readers. If it is the same reader, the latter features an anti-collision device enabling the reader to dialog with the various peripheral devices present on the card. In this case, the reader dialogs with the main chip and the peripheral devices as if they were connected to different antennas and/or placed on different cards.

The peripheral device(s) may also exploit data issued in the form of instructions by the main chip. In this embodiment, the dialog is carried by the antenna using the retromodulation resistor of the peripheral device, the main chip acting as a reader by modulating a signal by the data to be transmitted. In this case, only the main chip can dialog with the peripheral devices only if it is correctly supplied, which constitutes an element of security.

Another case of direct dialog with the main chip is the case where the peripheral device is a display device displaying the results of a transaction made by the main chip. Thus, the display device can display the amount of money remaining on the contactless smart card, if the latter is an electronic wallet. It can also display information related to card operation.

According to the embodiment illustrated in FIG. 1, the peripheral device 16 is a display device while the peripheral device 18 is a temperature sensor, such a card being used for instance for following through the cold production line for deep frozen products. When the card is introduced in the reader field, this one sends a request to the temperature sensor 18 and stores the value read in its memory. Then, it displays this value on the screen of the display device 16 thanks to the information signals transmitted between the reader and the card antenna. A mentioned previously, the value of the temperature provided by the sensor can be transmitted to the chip 12 which itself transmits this value to the display device 16 by modulation of the signals being received from the reader, the latter being used in such a case only to provide the power to the chip 12 and to the device 16 during the data exchange.

According to a second embodiment, the display maintains an after-image which allows the user to see the information at all times, after the transaction with the reader.

According to a specific embodiment, the peripheral device is a keyboard, and preferably a numeric keypad. This function can be of particular interest when the contactless smart card is used as an electronic wallet. Such a device can be used to enter the amount of money a user wants to transfer to the electronic wallet from a distributor. Such a keyboard may also be used to enter an access code. The operation of such a peripheral device requires only that the contactless object remain present in the reader's field during the input operation.

Finally, each of the peripheral devices has little impact on either the operation of the main chip or no the operation of the other peripheral devices of the portable object, or on the transactions which take place between the main chip, the other devices and their readers. In this manner, a malfunction should not have an impact on the functionality of the other elements of the contactless portable object, whether it be the main chip or the other peripheral devices. The user can thus always use the functions of the main chip and the other peripheral devices located on the card.

1. A contactless portable object (10) featuring a main chip (12) and an antenna (14) enabling electromagnetic signals to be communicated between said chip and a reader associated to said contactless portable object, said antenna terminals being connected to the terminals of said main chip.
said contactless portable object being characterized in that it also includes at least one contactless peripheral device (16, 18), other than a chip and having a function different than said main chip, connected in parallel to the terminals of said antenna and whose energy required to operate is extracted from the electromagnetic signals sent from said reader and supplied by said antenna.

2. The portable object (10) according to claim 1, in which said peripheral device includes a capacitor (42) which represents a tuning capacitor in combination with the capacitance of said main chip (22) so as to form a resonating circuit with said antenna (14) at the frequency of the electromagnetic signals.

3. The portable object (10) according to any one of claims 1 or 2, characterized in that said contactless peripheral device is a display device (16).

4. The portable object (10) according to any one of claims 1 to 5, characterized in that said contactless peripheral device is a keyboard.

5. The portable object (10) according any one of claim 1 to 3 characterized in that said contactless peripheral device is a temperature sensor

6. The portable object (10) according to any of the previous claims, in which said peripheral device (16, 18) can send information to said reader by retromodulation, by means of said antenna (14).

7. The portable object (10) according to previous claims, in which said peripheral device (16, 18) dialogs with said chip by modulation of the signals provided by said antenna.

8. The portable object (10) according to claim 6 or 7, in which said peripheral device (16, 18) includes, in parallel on the terminals of said antenna (14), a resistor (44) and a switch (46) which, when closed, allows information to be transmitted from said peripheral device to said reader or to said main chip (12).

9. The portable object (10) according to claims 1 to 3, characterized in that it is used as an electronic wallet.
